(19) United States
(12) Patent Application Publication
(10) Pub. No.: US 2026/0326092 A1
(43) Pub. Date: Oct. 22, 2026

(54) METHOD FOR SEPARATING AND REGENERATING ANION EXCHANGE RESIN AND CATION EXCHANGE RESIN IN ION EXCHANGE RESIN MIXTURE

(71) Applicant: KURITA WATER INDUSTRIES LTD., Tokyo (JP)

(72) Inventors: Yuuichi OGAWA, Tokyo (JP); Midori MIYAJI, Tokyo (JP)

(73) Assignee: KURITA WATER INDUSTRIES LTD., Tokyo (JP)

(21) Appl. No.: 19/110,429

(22) PCT Filed: Sep. 15, 2023
(86) PCT No.: PCT/JP2023/033723

§ 371 Date: Mar. 11, 2025

(30) Foreign Application Priority Data
Jan. 5, 2023 (JP) 2023-000518

(51) Int. Cl. B01J 49/57

(52) U.S. Cl. CPC B01J 49/57

(57) ABSTRACT

Provided is a method for separating and regenerating anion exchange resin and cation exchange resin in ion exchange resin mixture, in which a second aqueous NaOH solution that has been used in an anion exchange resin regeneration tower is recovered and used as a first aqueous NaOH solution that separates a cation exchange resin mixed in an anion exchange resin in a Seprex tower, and the anion exchange resin is regenerated.

### TECHNICAL FIELD

The invention relates to a method for separating and regenerating ion exchange resin mixture of anion exchange resin and cation exchange resin used in non-regenerative ion exchange devices or mixed-bed ion exchange devices used in pure water production device and the like.

### RELATED ART

In pure water production devices, impurities in raw water are removed to improve the cleanness of the water. In order to remove ionic impurities, i.e., anionic impurities and cationic impurities, a mixed-bed ion exchange device in which anion exchange resin and cation exchange resin are mixed and filled is generally used. This mixed-bed ion exchange device fails and cannot remove any more ionic impurities when the ion exchange resin exchanges an amount of ions equivalent to the ion exchange capacity. Therefore, after a certain amount of treated water is treated before failure, the ion exchange resin is recovered from the mixed-bed ion exchange device and regenerated with hydrochloric acid or caustic soda in a cation exchange resin regeneration tower and an anion exchange resin regeneration tower, respectively, and reused. At this time, the anion exchange resin and the cation exchange resin are generally separated by passing the water in an upward flow and using a difference in settlement speed due to the specific gravity difference between the anion exchange resin and the cation exchange resin.

An example of an ion exchange resin mixture separation tower (backwash separation tower) is shown in FIG. 2. In FIG. 2, the ion exchange resin mixture separation tower 21 includes a cylindrical separation tower body 21A with a water inlet and outlet 22 provided at the bottom, as well as a water supply pipe 23 serving as a water discharge part equipped with multiple discharge nozzles 23A, and a water outlet 24 formed at the top. A water collection plate 25 is positioned below the discharge nozzles 23A in this separation tower body 21A. Moreover, an anion exchange resin extraction plumbing 26, serving as an anion exchange resin extraction part, is provided near the middle in the up-down direction inside the separation tower 21, and a cation exchange resin extraction plumbing 27 is provided slightly above the water supply pipe 23 and below this anion exchange resin extraction plumbing 26. In addition, a peephole 28 is formed on the side of the separation tower 21. Moreover, 29 is an input port for the ion exchange resin mixture that has been used, located on the upper side of the separation tower 21.

In such the ion exchange resin mixture separation tower 21, the ion exchange resin mixture that has been used is input into the separation tower 21, followed by passing an aqueous NaOH solution of approximately 4% by weight through it. After allowing it to stand for a specified time to adjust the ion type of the ion exchange resin and crease the specific gravity difference, pure water is injected from the water inlet and outlet 22 to push out the aqueous NaOH solution inside the separation tower through the water outlet 24, performing cleaning. Then, a specified amount of separation water (pure water) is filled in the separation tower 21. At this time, the water surface of the separation water is made to be higher than the upper surface of the ion exchange resin mixture, particularly about 500 mm or less higher.

Next, air is injected into the separation tower from a water inlet and outlet 24, bubbling the ion exchange resin mixture to loosen the resin particles entangled in a colloidal state, and stopping the bubbling, then the ion exchange resin mixture is allowed to settle on the water collection plate 25. At this time, the cation exchange resin with higher specific gravity settles first, while the anion exchange resin with lower specific gravity settles later. Subsequently, in preparation for backwashing, pure water (separation water) is introduced from the water inlet and outlet 22 to fill the separation tower 21 completely.

In this fully filled state, pure water is discharged from the discharge nozzles 23A and passed through in an upward flow, and adjustment is made while visually confirming through the peephole 28 such that a separation interface is at the lower end of a suction port of the anion exchange resin extraction plumbing 26. Then, the anion exchange resin is suctioned out through the anion exchange resin extraction plumbing 26 and flowed out as an anion exchange resin-water mixed phase flow and removed. After draining, this anion exchange resin-water mixed phase flow is transferred to the anion exchange resin regeneration tower to perform regeneration treatment of the anion exchange resin.

After the anion exchange resin is extracted in this manner, pure water is continuously discharged from the discharge nozzle 23A while the cation exchange resin is suctioned through the cation exchange resin extraction plumbing 27, and flowed out as a cation exchange resin-water mixed phase flow and removed. This cation exchange resin-water mixed phase flow is drained and then transferred to a cation exchange resin regeneration separation tower for regeneration treatment of the cation exchange resin. At this time, the cation exchange resin is not completely removed, but a certain amount is left to prevent contamination with the anion exchange resin.

However, in the separation method of anion exchange resin and cation exchange resin as described above, there was a problem that the separation between the two was insufficient. In particular, while the cation exchange resin could be well separated by leaving the interface part remaining in the separation tower 21, there was a problem that the cation exchange resin was prone to mixing into the anion exchange resin that is first is extracted.

Therefore, a method called the Seprex method, which utilizes a high concentration aqueous NaOH solution to separate anion exchange resin and cation exchange resin, has been applied. This Seprex method performs processing with a system and process as shown in FIG. 3 and FIG. 4.

In other words, the ion exchange resin mixture separation and regeneration system is composed of four towers, a backwash separation tower, a Seprex tower, an anion exchange resin regeneration tower, and a cation exchange resin regeneration tower, as shown in FIG. 3. First, in the backwash separation tower, the anion exchange resin and the cation exchange resin are separated by the backwash separation step based on the specific gravity difference, and the anion exchange resin is extracted. At this time, by passing an aqueous NaOH solution through the ion exchange resin mixture, the cation exchange resin is modulated to the Na type and the anion exchange resin is modulated to the OH type, respectively, thereby increasing the specific gravity difference between the anion exchange resin and the cation exchange resin, and reducing the mixing rate of the anion exchange resin and the cation exchange resin after backwash separation.

In this backwash separation step, a small amount of cation exchange resin is mixed in with the separated anion exchange resin, and the cation exchange resin is transferred to the Seprex separation tower, which serves as a high-degree anion exchange resin separation tower. Then, in the state that aqueous NaOH solution with a specific gravity between the specific gravity of the anion exchange resin and the specific gravity of the cation exchange resin is injected in the Seprex separation tower, the resin is loosened by bubbling and left to stand still, causing the mixed cation exchange resin to settle to the lower side. This cation exchange resin is extracted and removed from the lower part of the Seprex separation tower. Then, pure water is supplied to the tower to push out and clean the aqueous NaOH solution, and the remaining anion exchange resin is extracted (Seprex separation step).

The extracted anion exchange resin is transferred to an anion exchange resin regeneration tower, where the anion exchange resin is further to regenerated and cleaned with an aqueous NaOH solution (anion exchange resin regeneration step). On the other hand, the cation exchange resin separated in the backwash separation step is transferred to the cation exchange resin regeneration tower, where and the cation exchange resin is further regenerated and cleaned by conventional methods (cation exchange resin regeneration step).

By the Seprex method as described above, the anion exchange resin and the cation exchange resin may be separated with extremely little mixing of the other. However, the Seprex method supplies and recovers aqueous NaOH solution using the mechanism and procedure shown in FIG. 4. Specifically, an aqueous NaOH solution supply and recovery mechanism 30 in the Seprex method supplies ultrapure water W from an ultrapure water supply source 34 via an ultrapure water supply pipe 35 to a backwash separation tower 31, a Seprex tower 32, and a anion exchange resin regeneration tower 33, while also supplying unused high concentration aqueous NaOH solution N from a high concentration aqueous NaOH solution tank 36, enabling the supply of aqueous NaOH solution at predetermined concentrations to each tower. The aqueous NaOH solution that has been used is then stored in a waste liquid tank 38 through a waste aqueous NaOH solution discharge pipe 37, where waste aqueous NaOH solution discharge branch pipes 37A, 37B, and 37C are merged, and is then discarded. 39A, 39B, and 39C are specific gravity meters for modulating the mixing ratio of the ultrapure water W and high concentration aqueous NaOH solution SH so as to supply aqueous NaOH solution at predetermined concentrations. Moreover, FIG. 4 is an explanatory diagram for the supply and recovery of aqueous NaOH solution, so the anion exchange resin regeneration tower is not shown.

### SUMMARY OF INVENTION

### Technical Problem

In this manner, conventionally, unused aqueous NaOH solution was used in each of the backwash separation step, Seprex separation step, and anion exchange resin regeneration step, and the aqueous NaOH solution after use was discarded. As a result, there was a problem of using a large amount of aqueous NaOH solution.

The invention is made in view of the above-mentioned problem, and aims to provide a method for separating and regenerating anion exchange resin and cation exchange resin in ion exchange resin mixture that can reduce the amount of aqueous NaOH solution used when separating anion exchange resin and cation exchange resin from ion exchange resin mixture using the Seprex method.

### Solution to Problem

In view of the objective, the invention provides a method for separating and regenerating anion exchange resin and cation exchange resin in ion exchange resin mixture, which is a method for separating and regenerating an anion exchange resin and a cation exchange resin from an ion exchange resin mixture of anion exchange resin and cation exchange resin. The method includes: a backwash separation step of inputting the ion exchange resin mixture into a substantially cylindrical ion exchange resin mixture backwash separation tower that includes an ion exchange resin mixture input part, an anion exchange resin extraction part provided midway in an up-down direction, a cation exchange resin extraction part provided below the anion exchange resin extraction part, and an air and separation water injection part provided at a bottom part, and passing separation water in an upward flow from the air and separation water injection part into the separation tower to separate the ion exchange resin mixture using a specific gravity difference; a transfer step of extracting the anion exchange resin above a separation interface between the anion exchange resin and the cation exchange resin from the anion exchange resin extraction part and transferring it to a high-degree anion exchange resin separation tower, and extracting the remaining cation exchange resin from the cation exchange resin extraction part and transferring it to a cation exchange resin regeneration tower; an anion exchange resin separation step of immersing the high-degree anion exchange resin separation tower in a first aqueous NaOH solution of 5% by weight or more and 30% by weight or less to separate the cation exchange resin mixed in the anion exchange resin and discharging the cation exchange resin; an anion exchange resin regeneration step of regenerating the anion exchange resin remaining in the high-degree anion exchange resin separation tower with a second aqueous NaOH solution; and a cation exchange resin regeneration step of regenerating the cation exchange resin in the cation exchange resin regeneration tower. In the method for separating and regenerating anion exchange resin and cation exchange resin in ion exchange resin mixture, an unused high concentration aqueous NaOH solution is used as the second aqueous NaOH solution, and the second aqueous NaOH solution that has been used in the anion exchange resin regeneration step or an aqueous NaOH solution recovered from the second aqueous NaOH solution that has been used in the anion exchange resin regeneration step and the first aqueous NaOH solution that has been used in the anion exchange resin separation step is used as the first aqueous NaOH solution (Invention 1).

According to this invention (Invention 1), by using the unused high concentration aqueous NaOH solution as the second aqueous NaOH solution for the regeneration of anion exchange resin in the final stage, and by recovering and reusing the already used second aqueous NaOH solution as the first aqueous NaOH solution for separating cation exchange resin in the high-degree anion exchange resin separation tower, it is possible to perform regeneration of anion exchange resin with high accuracy while reducing the amount of aqueous NaOH solution used.

In the above-mentioned invention (Invention 1), it is preferable that the unused high concentration aqueous NaOH solution is added to the first aqueous NaOH solution (Invention 2).

According to this invention (Invention 2), in the high-degree anion exchange resin separation tower, a higher concentration of aqueous NaOH solution is used compared to the anion exchange resin regeneration step, so merely recovering and reusing the already used second aqueous NaOH solution results in insufficient aqueous NaOH solution concentration. Therefore, by adding unused high concentration aqueous NaOH solution to achieve a suitable aqueous NaOH solution concentration for the anion exchange resin separation step, it is possible to both recover and reuse the already used second aqueous NaOH solution and achieve an appropriate aqueous NaOH solution concentration for the anion exchange resin separation step.

In the invention (Invention 2), it is preferable that a concentration of the second aqueous NaOH solution and/or the first aqueous NaOH solution is adjusted by pure water (Invention 3).

According to this invention (Invention 3), by adjusting the concentration of aqueous NaOH solution with pure water, it is possible to suitably perform the anion exchange resin regeneration step and the anion exchange resin separation step, respectively.

In the invention (Invention 1), in the backwash separation step of passing the separation water in an upward flow to separate the ion exchange resin mixture using the specific gravity difference, it is preferable that ion type adjustment is performed by passing a third aqueous NaOH solution through the ion exchange resin mixture, and a aqueous NaOH solution recovered from the second aqueous NaOH solution that has been used in the anion exchange resin regeneration step and the first aqueous NaOH solution that has been used in the anion exchange resin separation step is used as the third aqueous NaOH solution (Invention 4).

According to this invention (Invention 4), by using a aqueous NaOH solution recovered from the second aqueous NaOH solution that has been used in the anion exchange resin regeneration step and the first aqueous NaOH solution that has been used in the anion exchange resin separation step as the third aqueous NaOH solution for ion type adjustment, which is performed by passing the third aqueous NaOH solution through the ion exchange resin mixture in the backwash separation step of passing the separation water in an upward flow, it is possible to perform ion type adjustment with high accuracy, namely separation of cation exchange resin in the high-degree anion exchange resin separation tower and regeneration of anion exchange resin, while reducing the amount of aqueous NaOH solution used.

In the invention (Inventions 1 to 4), it is preferable that the anion exchange resin and cation exchange resin are porous type ion exchange resins (Invention 5).

According to this invention (Invention 5), the specific gravity of aqueous NaOH solution of 5% by weight or more and 30% by weight or less may be set between the specific gravity of porous type anion exchange resin and the specific gravity of porous type cation exchange resin. Therefore, in the anion exchange resin separation step, it is possible to suitably separate cation exchange resin mixed in the anion exchange resin by using the specific gravity difference.

### Effects of Invention

According to the method for separating and regenerating anion exchange resin and cation exchange resin in ion exchange resin mixture of the present invention, by recovering and reusing the already used recovered second aqueous NaOH solution as the first aqueous NaOH solution for separating cation exchange resin mixed in the anion exchange resin in the high-degree anion exchange resin separation tower, it is possible to perform regeneration of anion exchange resin with high accuracy while reducing the amount of aqueous NaOH solution used.

### BRIEF DESCRIPTION OF DRAWINGS

FIG. 1 is a schematic diagram showing a method for supplying and recovering aqueous NaOH solution in a method for separating and regenerating anion exchange resin and cation exchange resin in ion exchange resin mixture according to an aspect of the invention.

FIG. 2 is a schematic diagram showing an example of a separation tower for anion exchange resin and cation exchange resin of ion exchange resin mixture.

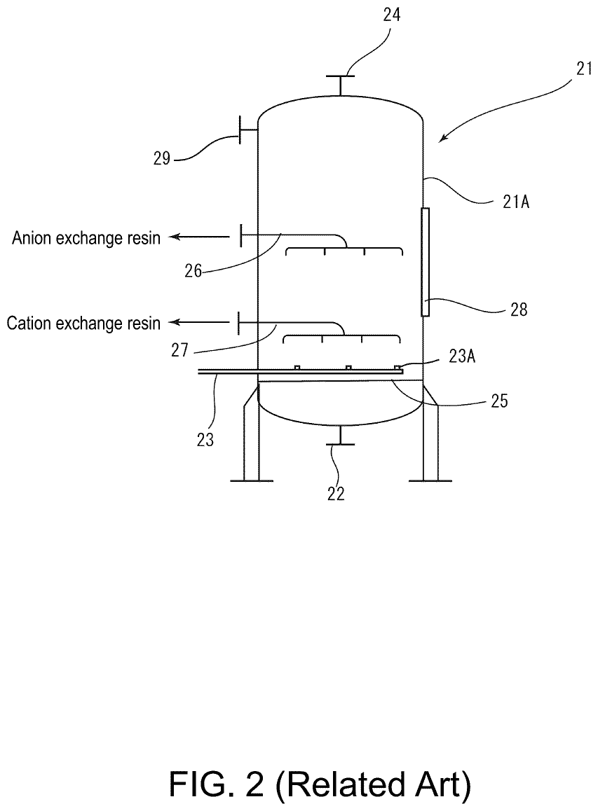

FIG. 3 is a flow diagram showing a separation and regeneration system for anion exchange resin and cation exchange resin in ion exchange resin mixture.

FIG. 4 is a schematic diagram showing a method for supplying and recovering aqueous NaOH solution in a conventional method for separating and regenerating anion exchange resin and cation exchange resin in ion exchange resin mixture.

### DESCRIPTION OF THE EMBODIMENTS

The method for separating and regenerating anion exchange resin and cation exchange resin in ion exchange resin mixture of the invention will be described in detail below with reference to the attached drawings.

### [Ion Exchange Resin Mixture Separation and Regeneration System]

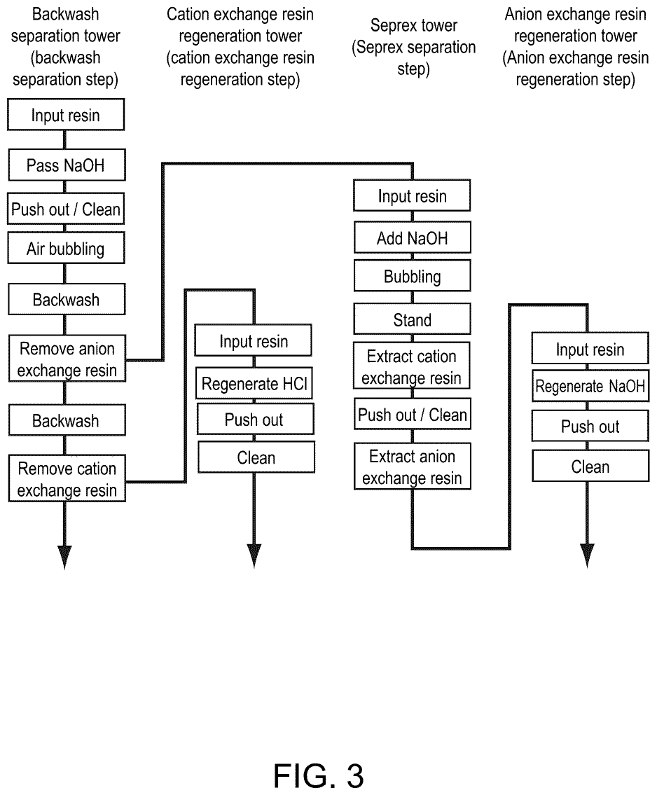

The separation and regeneration system for anion exchange resin and cation exchange resin in ion exchange resin mixture of this aspect is the same as the separation and regeneration system shown in FIG. 3 described above, so a detailed description thereof is omitted.

### (Aqueous NaOH Solution Supply and Recovery Mechanism)

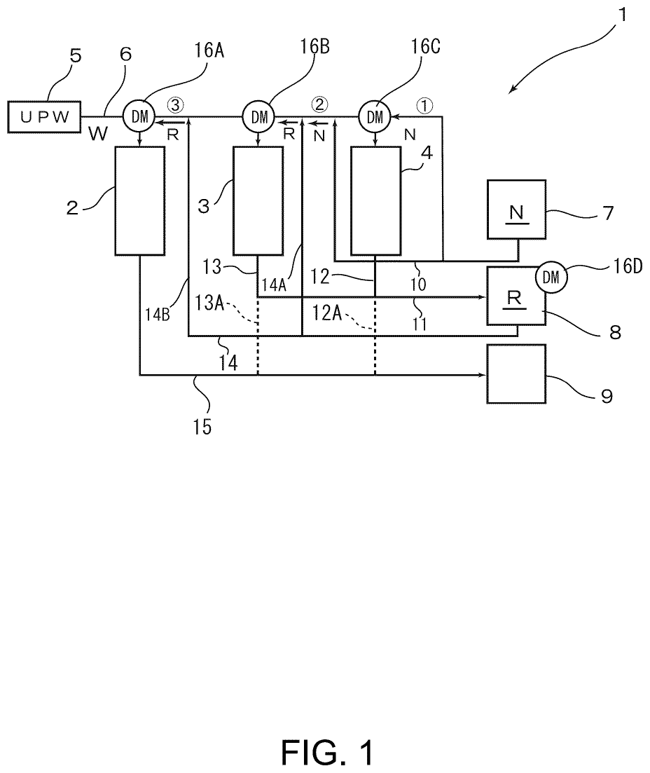

In this aspect, the supply and recovery of aqueous NaOH solution to each constituent element is performed by an aqueous NaOH solution supply and recovery mechanism 1 in the Seprex method with the configuration shown in FIG. 1. Specifically, the aqueous NaOH solution supply and recovery mechanism 1 includes a backwash separation tower 2, a Seprex tower 3 as a high-degree anion exchange resin separation tower, and an anion exchange resin regeneration tower 4, and is capable of supplying ultrapure water W via an ultrapure water supply pipe 6 from an ultrapure water supply source 5, as well as supplying unused high concentration aqueous NaOH solution N at a predetermined concentration to the regeneration tower 4 via an aqueous NaOH solution supply pipe 10 from a high concentration aqueous NaOH solution tank 7. In addition, 8 is a aqueous NaOH solution recovery and supply tank, which is capable of recovering aqueous NaOH solution that has passed through the anion exchange resin regeneration tower 4 and the Seprex tower 3 via recovery pipes 11, 12, and 13 respectively, and then supplying it as the aqueous NaOH solution R for reuse to the backwash separation tower 2 and the Seprex tower 3 via aqueous NaOH solution supply pipes 14, 14A, and 14B. Furthermore, 9 is a waste liquid tank, which is capable of recovering aqueous NaOH solution that has passed through the backwash separation tower 2 via a waste pipe 15. Moreover, 12A and 13A are spare waste pipes, and 16A, 16B, 16C, and 16D are specific gravity meters for modulating the mixing ratio of the ultrapure water W and high concentration aqueous NaOH solution SH so as to supply aqueous NaOH solution at a predetermined concentration. Moreover, since FIG. 1 is an explanatory diagram for the supply and recovery of aqueous NaOH solution, the anion exchange resin regeneration tower is not shown.

### (Method for Separating and Regenerating Ion Exchange Resin Mixture)

The method for separating and regenerating anion exchange resin and cation exchange resin in ion exchange resin mixture of this aspect is the same as the backwash separation step, anion exchange resin separation step (hereinafter referred to as the Seprex separation step), anion exchange resin regeneration step, and cation exchange resin regeneration step in the separation and regeneration system shown in FIG. 3 described above, so a detailed description thereof is omitted.

### (Method for Supplying and Recovering Aqueous NaOH Solution)

Next, the method for supplying and recovering aqueous NaOH solution in this aspect using the aqueous NaOH solution supply and recovery mechanism 1 with the aforementioned configuration will be described based on FIG. 1. Moreover, the method for supplying and recovering aqueous NaOH solution progresses in chronological order from the backwash separation step, to the anion exchange resin separation step, and then to the anion exchange resin regeneration step. However, in this aspect, for the sake of convenience in description, the description will be provided in the order of the anion exchange resin regeneration step, the Seprex separation step, and the backwash separation step.

### (Initial Stage)

In the initial state, it is preferable to store the already used aqueous NaOH solution in a waste liquid tank 9 by carrying out a backwash separation step, an anion exchange resin separation step, and an anion exchange resin regeneration step using an aqueous NaOH solution of a suitable concentration. In addition, the unused high concentration aqueous NaOH solution N is stored in the high concentration aqueous NaOH solution tank 7. The concentration of this high concentration aqueous NaOH solution N may be higher than the concentration of aqueous NaOH solution in the Seprex separation step to be described later, and may be appropriately set, for example, within the range of 25 to 48% by weight according to the concentration of aqueous NaOH solution in the Seprex separation step.

### (Anion Exchange Resin Regeneration Step)

In the anion exchange resin regeneration step, the ultrapure water W is supplied from the ultrapure water supply pipe 6, while the unused high concentration aqueous NaOH solution N is supplied to the anion exchange resin regeneration tower 4 via the aqueous NaOH solution supply pipe 10 from the high concentration aqueous NaOH solution tank 7. At this time, the NaOH concentration is confirmed based on the specific gravity of the solution supplied so as to the regeneration tower 4 using the specific gravity meter 16C, and the flow rates of the ultrapure water W and/or high concentration aqueous NaOH solution N are modulated as necessary to prepare aqueous NaOH solution of the desired concentration (for example, about 4% by weight). The regeneration of anion exchange resin as the final stage is performed using this clean aqueous NaOH solution. Then, the already used aqueous NaOH solution to be used for regeneration of this anion exchange resin is recovered from the recovery pipe 12 via the recovery pipe 11 to an aqueous NaOH solution recovery and supply tank 8. In addition, in the aqueous NaOH solution recovery and supply tank 8, the aqueous NaOH solution (more high concentration than that used in the regeneration step) used in the Seprex separation step, as described later, is also recovered and merged. Therefore, the aqueous NaOH solution stored in the aqueous NaOH solution recovery and supply tank 8 will be a more dilute aqueous NaOH solution compared to the aqueous NaOH solution used in the Seprex separation step.

Moreover, in this aspect, pure water, especially the ultrapure water W, is used for diluting the high concentration aqueous NaOH solution N and adjusting the concentration of aqueous NaOH solution. Here, as ultrapure water W, for example, resistivity: 18.1 MΩ·cm or more, fine particles: 1000 particles/L or less with a particle size of 50 nm or more, viable bacteria: 1 cell/L or less, TOC (Total Organic Carbon): 1 μg/L or less, total silicon: 0.1 μg/L or less, metals: 1 ng/L or less, ions: 10 ng/L or less, hydrogen peroxide: 30 μg/L or less, and water temperature: 25±2° C. are suitable.

### (Seprex Separation Step)

In the Seprex separation step, the ultrapure water W is supplied from the ultrapure water supply pipe 6, while the aqueous NaOH solution SH that has been used is supplied to the Seprex tower 3 via the aqueous NaOH solution supply pipes 14 and 14A from the aqueous NaOH solution recovery and supply tank 8. Here, since the concentration of aqueous NaOH solution used in the Seprex separation step is high, for example, about 9 to 25% by weight, the concentration of the recovered aqueous NaOH solution R stored in the aqueous NaOH solution recovery and supply tank 8 is insufficient. Thus, the insufficiency is estimated based on the aqueous NaOH solution concentration calculated by the specific gravity meter 16B, and high concentration aqueous NaOH solution N is supplied to the Seprex tower 3 via the aqueous NaOH solution supply pipe 10 from the high concentration aqueous NaOH solution tank 7. The separation using the Seprex method is performed (Seprex separation step) using both this aqueous NaOH solution R that has been used and high concentration aqueous NaOH solution N. Then, the aqueous NaOH solution used in this Seprex separation step is recovered to the aqueous NaOH solution recovery and supply tank 8 from the recovery pipe 13 via the recovery pipe 11. Moreover, it is preferable to also install a specific gravity meter 16D in the aqueous NaOH solution recovery and supply tank 8 to confirm the NaOH concentration of the solution stored in the recovery and supply tank 8.

### (Backwash Separation Step)

In the backwash separation step, the ultrapure water W is supplied from the ultrapure water supply pipe 6, while the aqueous NaOH solution R that has been used is supplied to the backwash separation tower 2 via the aqueous NaOH solution supply pipes 14 and 14B from the aqueous NaOH solution recovery and supply tank 8. At this time, the NaOH concentration is confirmed based on the specific gravity of the solution supplied to the backwash separation tower 2 using the specific gravity meter 16A, and the flow rates of the ultrapure water W and/or recovered aqueous NaOH solution R are modulated as necessary to prepare an aqueous NaOH solution with the desired concentration (for example, about 4% by weight). This aqueous NaOH solution R that has been used is used to perform ion type adjustment in the backwash separation step. Then, the aqueous NaOH solution used for this ion type adjustment is recovered to the waste liquid tank 9 from the waste pipe 15, and may be discarded after undergoing prescribed treatment.

Moreover, if the aqueous NaOH solution after the Seprex separation step and regeneration step cannot be reused due to water quality issues, it may be recovered to the waste liquid tank 9 from the spare waste pipes 12A and 13A, and discarded after undergoing prescribed treatment.

The invention has been described based on the aforementioned aspect, but the invention is not limited to the aforementioned aspect and various modification examples are possible. For example, the device for implementing the Seprex method may be applied to various configurations, and for instance, the configuration may be such that both the Seprex separation step and the anion exchange resin regeneration step are performed within the Seprex tower.

### EMBODIMENT

The invention is further described in detail by the following specific embodiment.

### Embodiment 1

A separation and regeneration device for anion exchange resin and cation exchange resin of ion exchange resin mixture was configured with an ion exchange resin mixture backwash separation tower, a cation exchange resin regeneration tower, a Seprex separation tower, and an anion exchange resin regeneration tower. The separation and purification of anion exchange resin and cation exchange resin, and the regeneration of anion exchange resin were performed according to the process shown in FIG. 3. At this time, the aqueous NaOH solution was supplied and recovered by the method shown in FIG. 1.

The mixed resin to be separated was 600 L, with a ratio of cation resin to anion resin of 1:1. A porous type anion exchange resin with a specific gravity of 1.05 g/mL (when wet) was used as the anion exchange resin, and a porous type cation exchange resin with a specific gravity of 1.28 g/mL (when wet) was used as the cation exchange resin.

The unused high concentration aqueous NaOH solution N was diluted with the ultrapure water W and supplied from the high concentration aqueous NaOH solution tank 7 to the anion exchange resin regeneration tower 4. The aqueous NaOH solution used in the anion exchange resin regeneration step and the Seprex separation step to be described later was received in the recovery and supply tank 8, and supplied to the Seprex separation tower 3 as the aqueous NaOH solution R for reuse, and the unused high concentration aqueous NaOH solution N and, as needed, ultrapure water W were added to make up for the shortage of NaOH concentration. The aqueous NaOH solution R for reuse in the recovery and supply tank 8 was reused in the ion type adjustment in the backwash separation tower 2.

In the ion type adjustment step of the backwash separation step, aqueous NaOH solution adjusted to 4% by weight was used, and the regeneration level was set at 200 g-NaOH/LR with respect to the anion resin. Here, the regeneration level [g-regenerating agent (NaOH)/LR] represents the amount of regenerating agent (converted to 100%) used in relation to the resin amount. Here, as it is in relation to the anion resin amount, it represents the regenerating agent usage amount for 300 L of anion exchange resin, not for the 600 L of mixed resin.

In the Seprex separation step, aqueous NaOH solution adjusted to 16% by weight was used, and the amount of aqueous NaOH solution used was 1.5 times (by volume) the amount of anion exchange resin.

In the regeneration step, aqueous NaOH solution of 4% by weight was used, and the regeneration level was set at 50 g-NaOH/LR with respect to the anion resin.

The amounts of aqueous NaOH solution (converted to 100%) used in these backwash separation step, Seprex separation step, and regeneration step are shown in Table 1. As reference material, the specific gravity of 16% aqueous NaOH solution, the specific gravity of cation exchange resin (H type) before ion type adjustment, the specific gravity of anion exchange resin (OH type) before ion type adjustment, and the specific gravity of cation exchange resin (Na type) after ion type adjustment are shown in Table 2, respectively.

TABLE 1

| | Backwash | Seprex | Regenera- | |
|---|---|---|---|---|
| Step Name | Separation | separation | tion | Total |
| Regeneration level | 200 | — | 50 | |
| (g-NaOH/LR) | | | | |
| aqueous NaOH solution used | (60) | 72 | 15 | 87 |
| (L: 100% conversion) | | | | |

TABLE 2

| | | Specific |
|---|---|---|
| | | gravity |
| Target substance | | (g/cm³) |
| 16% by weight of aqueous NaOH solution | | 1.18 |
| Before ion type adjustment | Cation exchange resin (H type) | 1.20*² |
| | Anion exchange resin (OH type) | 1.06*² |
| After ion type adjustment*¹ | Cation exchange resin (Na type) | 1.30*² |

※¹When NaOH is passed through, the anion exchange resin remains in the OH type even after ion type adjustment
※²The specific gravity of the ion exchange resin is based on the actual measured value.

As evident from Table 1, the aqueous NaOH solution required for backwash separation is 60 L. However, since the aqueous NaOH solution used in the Seprex separation step and regeneration step is reused, the actual amount is “0”, and the amount of aqueous NaOH solution discarded was 87 L.

### Comparative Example 1

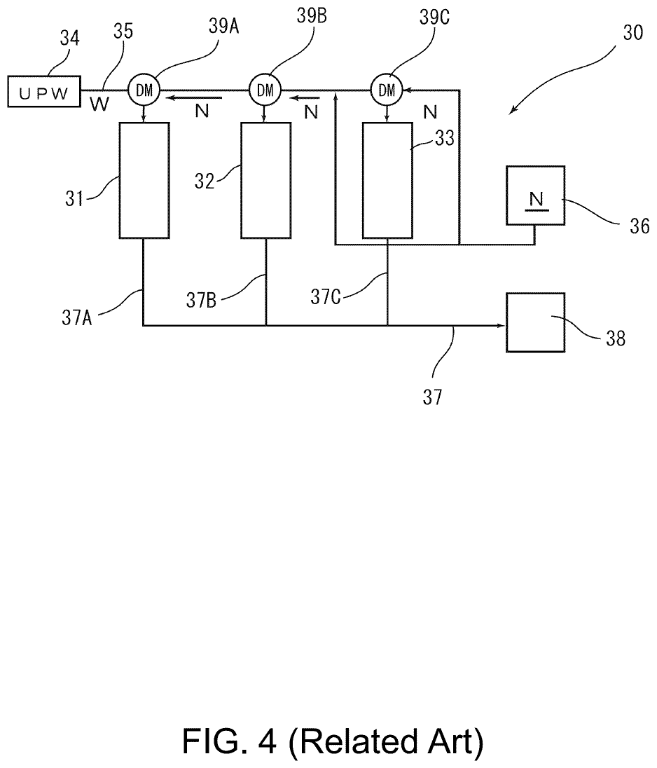

The separation and regeneration device for anion exchange resin and cation exchange resin of ion exchange resin mixture was configured with an ion exchange resin mixture backwash separation tower, a cation exchange resin regeneration tower, a Seprex separation tower, and an anion exchange resin regeneration tower. The separation and purification of anion exchange resin and cation exchange resin, and the regeneration of anion exchange resin were performed according to the process shown in FIG. 3. At this time, the aqueous NaOH solution was supplied and recovered by the method shown in FIG. 4.

The mixed resin to be separated was 600 L, with a ratio of cation resin to anion resin of 1:1. A porous type anion exchange resin with a specific gravity of 1.05 g/mL (when wet) was used as the anion exchange resin, and a porous type cation exchange resin with a specific gravity of 1.28 g/mL (when wet) was used as the cation exchange resin.

The aqueous NaOH solution used in each step of the regeneration step in the anion exchange resin regeneration tower 4, the Seprex separation step in the Seprex separation tower 3, and the backwash separation step in the backwash separation tower 2 was not reused, but was discarded.

In the ion type adjustment step of the backwash separation step, aqueous NaOH solution adjusted to 4% by weight was used, and the regeneration level was set at 200 g-NaOH/LR with respect to the anion resin.

In the Seprex separation step, aqueous NaOH solution adjusted to 16% by weight was used, and the amount of aqueous NaOH solution used was 1.5 times (by volume) the amount of anion exchange resin.

In the regeneration step, aqueous NaOH solution of 4% by weight was used, and the regeneration level was set at 50 g-NaOH/LR with respect to the anion resin.

The amounts of aqueous NaOH solution (converted to 100%) used in these backwash separation step, Seprex separation step, and regeneration step are shown in Table 3.

TABLE 3

| | Backwash | Seprex | Regenera- | |
|---|---|---|---|---|
| Step name | separation | separation | tion | Total |
| Regeneration level | 200 | — | 50 | |
| (g-NaOH/LR) | | | | |
| aqueous NaOH solution used | 60 | 72 | 15 | 147 |
| (L: 100% conversion) | | | | |

As evident from Table 3, it is clear that in the case where the aqueous NaOH solution used in implementing the backwash separation step, Seprex separation step, and anion exchange resin regeneration step is unused and temporarily discarded, the total consumption amount is 147 L, which is an increase of 60 L (65% or more) of the amount of NaOH waste liquid compared to Embodiment 1.

### REFERENCE SIGNS LIST

1 Aqueous NaOH solution supply and recovery Mechanism
2 Backwash separation tower
3 Seprex Tower (high-degree anion exchange resin separation tower)
4 Anion exchange resin regeneration tower
5 Ultrapure water supply source
6 Ultrapure water supply pipe
7 High concentration aqueous NaOH solution Tank
8 Aqueous NaOH solution recovery and supply Tank
9 Waste liquid tank
10 Aqueous NaOH solution supply pipe
11, 12, 13 Recovery pipe
12A 13A Spare waste pipe 114, 14A, 14B Aqueous NaOH solution supply pipe
15 Waste pipe
16A, 16B, 16C, 16D Specific gravity meter
W Ultrapure water
N High concentration aqueous NaOH Solution
R Aqueous NaOH solution for reuse

To the claims:

1. A method for separating and regenerating anion exchange resin and cation exchange resin in ion exchange resin mixture, which is a method for separating and regenerating an anion exchange resin and a cation exchange resin from an ion exchange resin mixture of anion exchange resin and cation exchange resin, the method comprising:
a backwash separation step of inputting the ion exchange resin mixture into a substantially cylindrical ion exchange resin mixture backwash separation tower, which comprises an ion exchange resin mixture input part, an anion exchange resin extraction part provided midway in an up-down direction, a cation exchange resin extraction part provided below the anion exchange resin extraction part, and an air and separation water injection part provided at a bottom part, and passing separation water in an upward flow from the air and separation water injection part into the separation tower to separate the ion exchange resin mixture using a specific gravity difference;
a transfer step of extracting the anion exchange resin above a separation interface between the anion exchange resin and the cation exchange resin from the anion exchange resin extraction part and transferring it to a high-degree anion exchange resin separation tower, and extracting the remaining cation exchange resin from the cation exchange resin extraction part and transferring it to a cation exchange resin regeneration tower;
an anion exchange resin separation step of immersing the high-degree anion exchange resin separation tower in a first aqueous NaOH solution of 5% by weight or more and 30% by weight or less to separate the cation exchange resin mixed in the anion exchange resin and discharging the cation exchange resin;
an anion exchange resin regeneration step of regenerating the anion exchange resin remaining in the high-degree anion exchange resin separation tower with a second aqueous NaOH solution; and
a cation exchange resin regeneration step of regenerating the cation exchange resin in the cation exchange resin regeneration tower; wherein
in the method for separating and regenerating anion exchange resin and cation exchange resin in ion exchange resin mixture,
an unused high concentration aqueous NaOH solution is used as the second aqueous NaOH solution, and the second aqueous NaOH solution that has been used in the anion exchange resin regeneration step or an aqueous NaOH solution recovered from the second aqueous NaOH solution that has been used in the anion exchange resin regeneration step and the first aqueous NaOH solution that has been used in the anion exchange resin separation step is used as the first aqueous NaOH solution.

2. The method for separating and regenerating anion exchange resin and cation exchange resin in ion exchange resin mixture according to claim 1, wherein the unused high concentration aqueous NaOH solution is added to the first aqueous NaOH solution.

3. The method for separating and regenerating anion exchange resin and cation exchange resin in ion exchange resin mixture according to claim 2, wherein a concentration of the second aqueous NaOH solution and/or the first aqueous NaOH solution is adjusted by pure water.

4. The method for separating and regenerating anion exchange resin and cation exchange resin in ion exchange resin mixture according to claim 1, wherein in the backwash separation step of passing the separation water in an upward flow to separate the ion exchange resin mixture using the specific gravity difference, ion type adjustment is performed by passing a third aqueous NaOH solution through the ion exchange resin mixture, and a aqueous NaOH solution recovered from the second aqueous NaOH solution that has been used in the anion exchange resin regeneration step and the first aqueous NaOH solution that has been used in the anion exchange resin separation step is used as the third aqueous NaOH solution.

5. The method for separating and regenerating anion exchange resin and cation exchange resin in ion exchange resin mixture according to claim 1, wherein the anion exchange resin and cation exchange resin are porous type ion exchange resins.
